(19) United States
(12) Patent Application Publication
(10) Pub. No.: US 2011/0241349 A1
(43) Pub. Date: Oct. 6, 2011

(54) Windmill generator

(76) Inventor: Pat Sankar, Tustin, CA (US)

(21) Appl. No.: 12/798,223

(22) Filed: Mar. 31, 2010

(51) Int. Cl. F03D 9/00

(52) U.S. Cl. 290/55

(57) ABSTRACT

A windmill generator includes a windmill hub; at least one windmill blade carried by the windmill hub; a rotor carried by at least one of the windmill hub and the windmill blade and having a plurality of rotor magnets with dominant north poles and dominant south poles, respectively; and a stator having a plurality of stator coils disposed adjacent to the rotor magnets of the rotor, with the rotor rotatable with respect to the stator.

### TECHNICAL FIELD

The disclosure generally relates to wind-actuated electrical generators. More particularly, the disclosure relates to a windmill generator having a magnet configuration with enhanced magnetic flux.

### BACKGROUND

The explosive and excessive demands on energy consumption by contemporary society has brought it to the brink of disaster in terms of the survivability of the planet. Though the sources of energy range from petroleum, natural gas, hydro electricity, solar energy, fossil fuels, coal, geothermal sources, nuclear energy, wind mills and even unconventional sources such as lightning, the increase in demand for energy consumption is clearly outpacing the supply. A recent report on global energy outlook for 2009 has predicted a drastic increase in energy use in 2009 and beyond.

Petroleum and other liquid fuels continue to remain the most important fuels for transportation, as there exist very few alternatives on the horizon that can be expected to compete widely with petroleum-based liquids. The International Energy Agency (IEA) forecasts that energy demand between now and 2030 will increase by a half, an annual average increase of 1.6%. Two-thirds of the new energy demand will be contributed by developing nations, with China accounting for 30%.

However, this trend cannot continue without drastic consequences to the environment and subsequently to the longevity and quality of human life itself, especially due to greenhouse gas emissions. Humanity appears to be at the crossroads of the “make or break decision point” with respect to energy policy, energy production methods and energy consumption. It is imperative that strides in the development of alternative, environmentally-friendly energy sources be made at this critical juncture.

In addition, the socioeconomic impacts of rising fuel costs on the world's countries are equally if not more devastating. Prior to the current world economic recession, demand outpaced the supply for fossil fuels and the move toward biofuel substitutes contributed to a 45% increase in food prices (in the 15 months between December 2006 and March 2008). The surge in food prices was led by some major food crops (corn, soybeans, wheat, and edible oil), and spread to other staples including rice.

The social implications of rising food prices can be particularly severe for the urban poor. Some countries in Africa have suffered riots related to food prices. In Cameroon, political unrest has led to protests over food and fuel prices. Niger has also suffered food-price-related riots, while in Indonesia there have been protests over soybean shortages. Continuation of this trend will eventually propagate social unrest to poorer areas of more developed nations including the United States.

The harnessing of electricity from the use of windmills is one of the most logical and plausible alternative source of energy, not only in terms of its minimal environmental impact but also in terms of the abundance of this resource that is readily available and usable. We propose a unique design which will be not only environmentally friendly, but is at the time very simple, most practical and is applicable in a variety of situations.

Accordingly, a windmill generator having a novel arrangement of magnets with increased magnetic flux is needed.

### SUMMARY

The disclosure is generally directed to a windmill generator. An illustrative embodiment of the windmill generator includes a windmill hub; at least one windmill blade carried by the windmill hub; a rotor carried by at least one of the windmill hub and the windmill blade and having a plurality of rotor magnets with dominant north poles and dominant south poles, respectively; and a stator having a plurality of stator coils disposed adjacent to the rotor magnets of the rotor, with the rotor rotatable with respect to the stator.

### BRIEF DESCRIPTION OF THE DRAWINGS

The disclosure will now be made, by way of example, with reference to the accompanying drawings, in which:

FIG. 1 is a schematic diagram of a single phase electromagnetic generator/motor having a magnet configuration which is suitable for implementation of an illustrative embodiment of the windmill generator;

FIG. 2 is a schematic diagram of a single phase electromagnetic generator/motor having three pairs of permanent magnets and three coils;

FIG. 3A is a partially schematic perspective view of a rotor element of an electromagnetic generator/motor which is suitable for implementation of an illustrative embodiment of the windmill generator;

FIG. 3B is a partially schematic perspective view of a stator element of the electromagnetic generator/motor;

FIG. 3C is a perspective view of an electromagnetic generator/motor which includes the rotor of FIG. 3A and the stator of FIG. 3B;

FIG. 3D is a wiring diagram of the stator element of the electromagnetic generator/motor illustrated in FIG. 3C;

FIG. 4 is a schematic front view of an illustrative stationary embodiment of the windmill generator;

FIG. 5 is a schematic front view of an alternative stationary embodiment of the windmill generator;

FIG. 6 is a schematic diagram of an illustrative embodiment of a portable windmill generator;

FIG. 6A is a side view of a hybrid electric vehicle with a pair of an illustrative embodiment of a portable windmill generator provided on respective wheels of the automobile and an additional portable windmill generator provided on a hood of the vehicle;

FIG. 6B is a front view of a hybrid electric vehicle with a pair of portable windmill generators provided on respective side view mirrors of the vehicle and an additional pair of the portable windmill generators provided on a hood of the vehicle;

FIG. 7 is a schematic side view of a vehicle wheel with an illustrative embodiment of the portable windmill generator provided on the vehicle wheel;

FIG. 8A is a front view of a vehicle headlight with multiple portable windmill generators provided on the headlight;

FIG. 8B is a rear view, partially in section, of a vehicle side view mirror, with a portable windmill generator provided on a mirror backside of the vehicle side view mirror;

FIG. 9 is a schematic block diagram which illustrates multiple energy sources including windmill energy for a hybrid electric vehicle;

FIG. 10A is a perspective view of a locomotive with multiple portable windmill generators provided at various locations on the locomotive;

FIG. 10B is a perspective view of a bus, with a pair of portable windmill generators provided on a front of the bus;

FIG. 11A is a perspective view of a cargo ship, with multiple portable windmill generators provided at various locations on the cargo ship;

FIG. 11B is a front view of a jet engine, with multiple magnetic motor/generators provided on the jet engine;

FIG. 12 is a schematic diagram of a turbojet engine, with multiple magnetic motor/generators provided in the air intake and coupled to a compressor of the jet engine;

FIG. 13 is a side view of a bicycle, with a pair of portable windmill generators provided on the handlebars and front wheel, respectively, of the bicycle;

FIG. 14 is a rear perspective view of a runner, with a hat provided on the head of the runner and a portable windmill generator provided on the hat.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

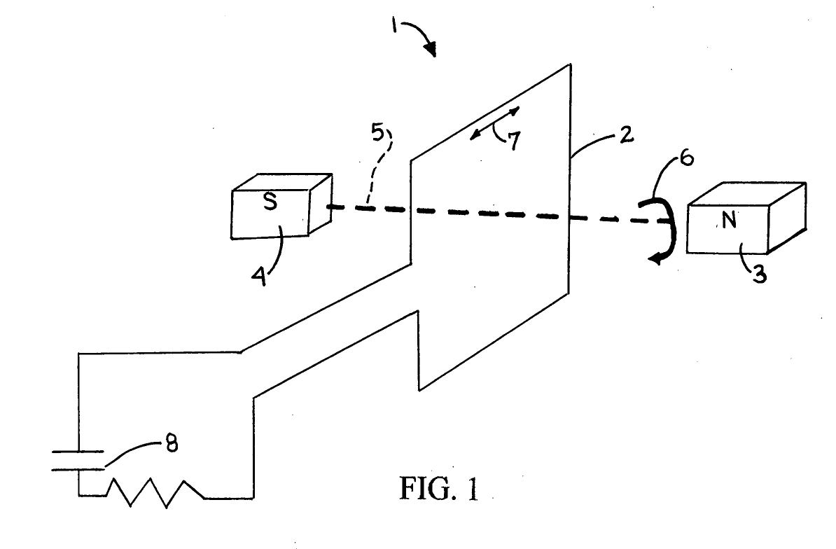

Referring initially to FIG. 1 of the drawings, a schematic diagram of an exemplary single phase electromagnetic generator/motor having a magnet configuration which is suitable for implementation of an illustrative embodiment of the windmill generator is generally indicated by reference numeral 1. The electromagnetic generator/motor 1 may have a magnet configuration (hereinafter referred to as a Ronbach array) which may be similar to a Halbach array but with increased magnetic flux. The electromagnetic generator/motor 1 illustrated in FIG. 1 includes a coil 2 with a single winding. A first magnet 3 having a dominant north pole and a second magnet 4 having a dominant south pole are disposed on opposite sides of the coil 2 such that the coil 2 is disposed within the focused magnetic field 5 of the first magnet 3 and the second magnet 4. The first magnet 3 and the second magnet 4 may rotate about the coil 2, as indicated by the arrow 6, to electromagnetically induce a magnetic flux 7 and an electromotive force (EMF) 8 in the coil 2.

If the base magnet of an electromagnetic generator with a Ronbach array has a field strength of B, the nth order Ronbach magnet will have a magnetic flux given by

B_{R}=3^{n/2}B

If this magnet is used in the electromagnetic generator/motor 1 shown in FIG. 1, the EMF 8 produced by the generator 1 is given by

V_{R}=3^{n/2}BIu

where I is the current in amperes and u is the velocity of the coil 2.

The torque produced by the electromagnetic motor/generator 1 is given by

T_{R}LN(3^{n/2}BIub)

where N is the number of turns of the coil 2, L is the length and b the width of the coil 2 in the magnetic field 5.

Compared with the use of the traditional magnet, the improvement in EMF 8 as well as the torque generated by the electromagnetic generator/motor 1 is given by (3^{n/2}).

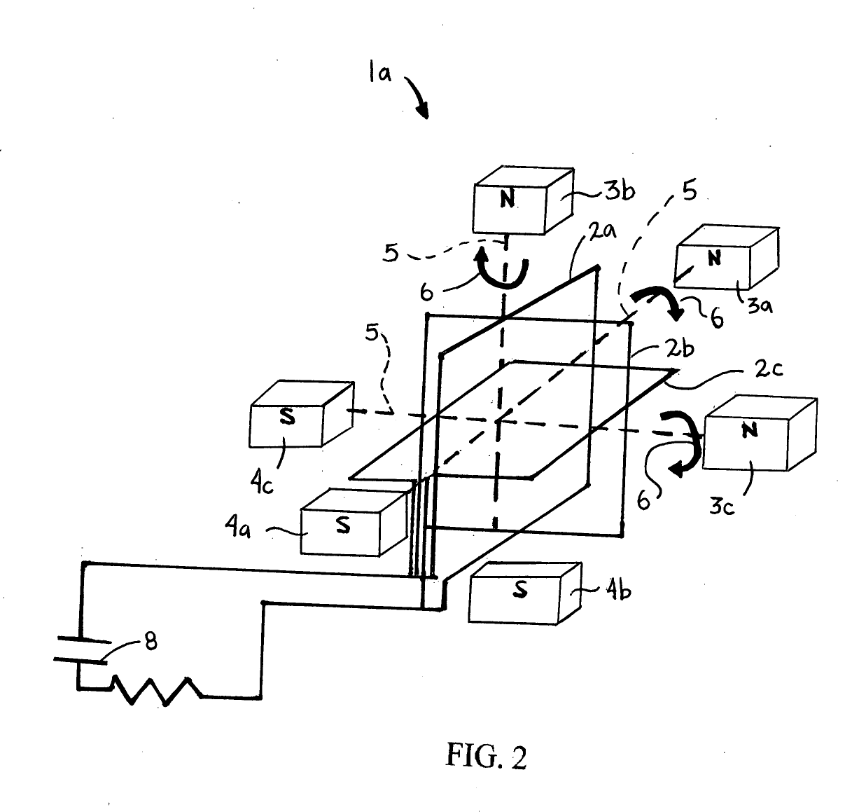

Referring next to FIG. 2 of the drawings, a schematic diagram a single phase electromagnetic generator/motor having three pairs of permanent magnets 3a-3c and 4a-4c, respectively, and three coils 2a-2c in a Ronbach array is generally indicated by reference numeral 1a. The magnets 3a-3c may each have a dominant north pole whereas the magnets 4a-4c may each have a dominant south pole. The improvement in EMF and torque generated by the electromagnetic generator/motor 1a is given by 3^{(n+1)/2}.

TABLE I
Increase in Torque as well as EMF for Ronbach
Generators/Motors (theoretically predicted maximum values)

| No. | TRF = VRF = (3^{n/2}) | TR3F = VR3F = (3) * (3^{n/2}) |
|---|---|---|
| 1 | 1.73 for n = 1 | 5.19 for n = 1 and m = 3 |
| | (73% increase) | (419% increase) |
| 2 | 3.0 for n = 2 | 9.0 for n = 2 and m = 3 |
| | (200% increase) | (800% increase) |
| 3 | 5.2 for n = 3 | 15.60 for n = 3 and m = 3 |
| | (420% increase) | (1460% increase) |

As illustrated in Table I (above), the Ronbach magnetic array of both the electromagnetic generator/motor 1 (FIG. 1) and the electromagnetic generator/motor 1a (FIG. 1A) improve the output of EMF 8 and torque significantly over conventional single-magnet arrays.

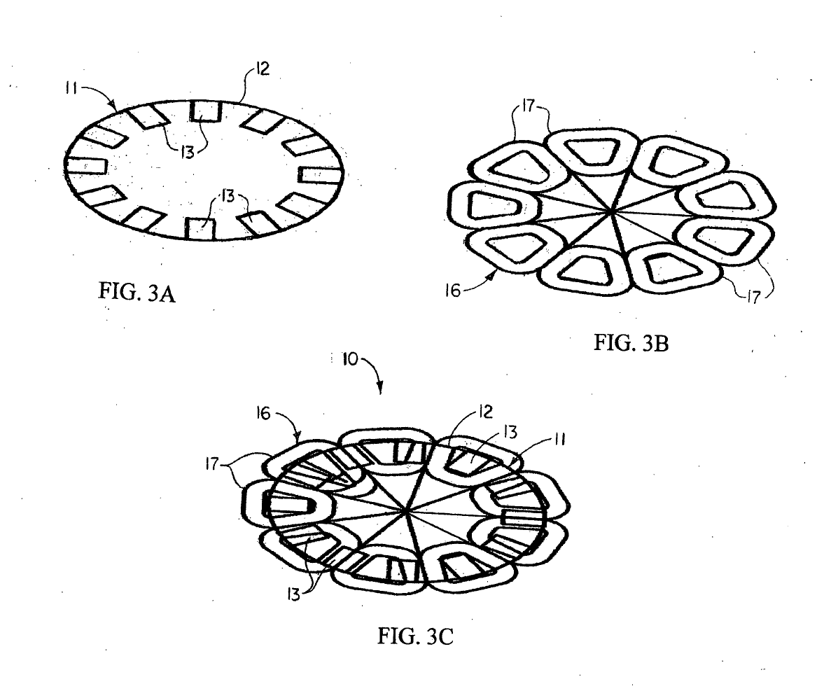

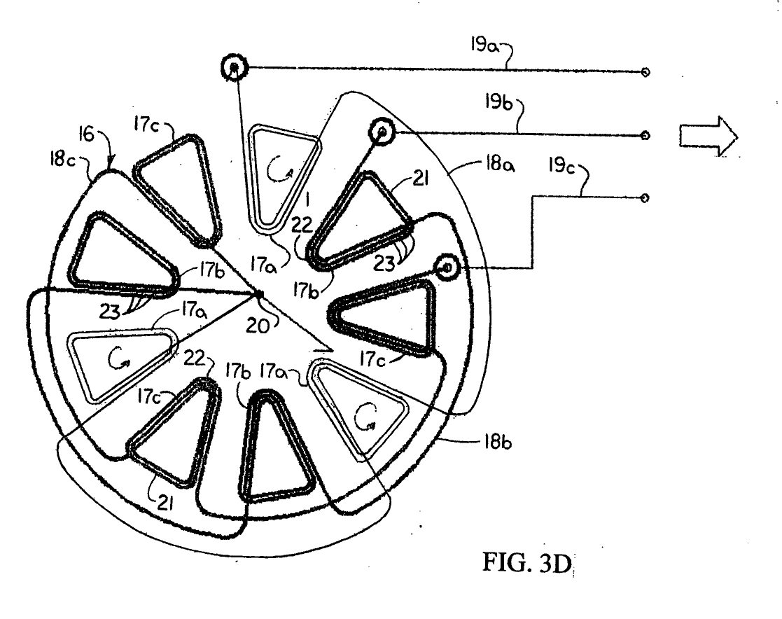

Referring next to FIGS. 3A-3D of the drawings, an exemplary design of a three-phase electromagnetic generator/motor which has a Ronbach magnet array and is suitable for implementation of an illustrative embodiment of the windmill generator is generally indicated by reference numeral 10 in FIG. 3C. The Ronbach magnet array of the electromagnetic generator/motor 10 may be compatible with the design of both AC motors and DC motors.

The electromagnetic generator/motor 10 may include a rotor 11 and a stator 16 which is disposed in adjacent proximity to the rotor 11. The rotor 11 may include a rotor frame 12 on which is provided multiple rotor magnets 13. Each of the rotor magnets 13 may have a dominant north pole or a dominant south pole. The rotor frame 12 of the rotor 11 may be arranged in a generally circular configuration, as illustrated. The rotor magnets 13 may extend inwardly from the rotor frame 12 in generally adjacent, spaced-apart relationship with respect to each other around the circumference of the rotor frame 12 and may be disposed in generally a common plane with each other and the rotor frame 12. In some embodiments, the rotor 11 may include 12 magnets 13 provided around the rotor frame 12. In other embodiments, a greater or lesser number of magnets 12 may be provided on the rotor frame 12. The rotor magnets 13 may be arranged in diametrically-opposed pairs having opposite polarity on opposite sides of the rotor frame 12.

The stator 16 of the electromagnetic generator/motor 10 may include multiple, adjacent stator coils 17 which may be arranged in a generally circular or star-shaped configuration, as illustrated. The stator coils 17 of the stator 16 may be disposed generally within a common plane. In some embodiments, the stator 16 may include 9 coils 17. In other embodiments, the stator 16 may include a greater or lesser number of coils 17. In some embodiments, the coils 17 of the stator 16 may be wound from different coil wirings 18. The coils 17 which are wound from different coil wirings 18 may alternate with each other around the stator 16. For example and without limitation, in the embodiment of the stator 16 which is illustrated in FIG. 3D, three of the coils 17a are wound from the same coil wiring 18a; three of the coils 17b are wound from the same coil wiring 18b; and three of the coils 17c are wound from the same coil wiring 18c. The coils 17a, 17b and 17c alternate with each other around the stator 16. The ends of the coil wirings 18a, 18b and 18c may terminate on a common wiring junction 20 which may be generally at the center of the stator 16. Coil outputs 19a, 19b and 19c extend from the opposite ends of the respective coil wirings 18a, 18b and 18c, respectively. The coil outputs 19a, 19b and 19c may ultimately be connected to an electrical power storage facility (not illustrated) such as a battery, for example and without limitation. Alternatively, the outputs 19a, 19b and 19c may be connected to an electrical component (not illustrated) to provide a source of operating electrical power to the component.

As further illustrated in FIG. 3D, each stator coil 17 may be shaped in such a manner that the stator coil 17 has an outer coil end 21 which faces the outside of the stator 16 and an inner coil end 22 which generally faces the interior or wiring junction 20 of the stator 16. In some embodiments, the outer coil end 21 may be generally flat and the inner coil end 22 may be generally tapered, as illustrated. In other embodiments, alternative shapes for each stator coil 17 are possible. Each coil 17 has a selected number of coil windings 23 of the coil wiring 18. In some embodiments, each coil 17 may have 3 coil windings 23, as illustrated. In other embodiments, each coil 17 may have a greater or lesser number of coil windings 23.

In some applications of the electromagnetic generator/motor 10, which will be hereinafter described, the stator 16 may be provided on a stationary component (not illustrated) of a windmill, vehicle or other object. The rotor 11 may be provided on a component (not illustrated) which moves relative to the stator 16 such that the stator coils 17 of the stator 16 are disposed within the magnetic fields of the magnets 13 on the rotor 11. Accordingly, as the rotor 11 moves with respect to the stator 16, the magnets 13 on the rotor 11 induce magnetic flux and generate an electromotive force (EMF) in the stator coils 17 of the stator 16. The resulting electrical current which is generated by the EMF in the stator coils 17 may be distributed from the coils 17 through the respective coil outputs 19 to a battery or other electrical power storage facility (not illustrated) for storage of the electrical current or may be distributed directly to an electrical component (not illustrated) for powering of the component. The Ronbach array of the rotor magnets 13 on the rotor 11 and the stator coils 17 on the stator 16 induces a magnetic flux and EMF which are enhanced relative to that which can be attained using standard or conventional single-magnet arrays in electromagnetic generators.

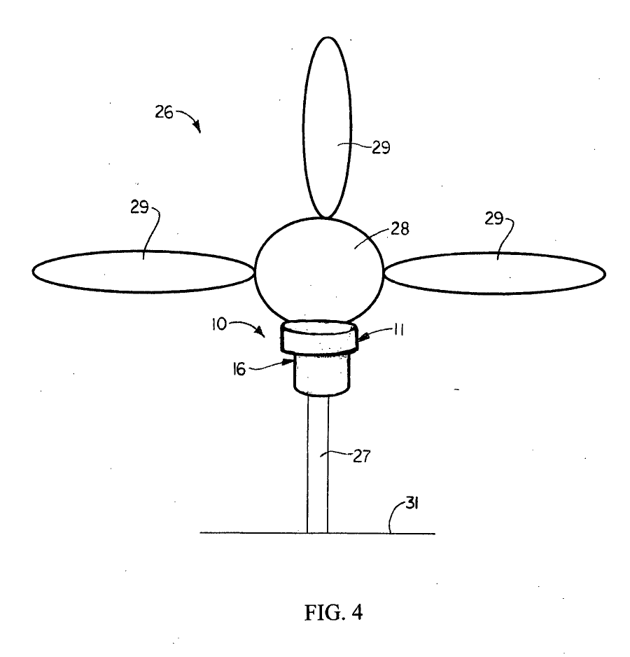

Referring next to FIG. 4 of the drawings, an illustrative stationary embodiment of a windmill generator which utilizes a magnetic motor/generator 10 is generally indicated by reference numeral 26. The windmill generator 26 may include a windmill support 27 which may be provided in the ground 31 in a windy area such as on a hilltop, for example and without limitation. A windmill hub 28 may be mounted for rotation on the windmill support 27 according to the knowledge of those skilled in the art. Windmill blades 29 may extend outwardly from the windmill hub 28. Accordingly, wind is exerted against the windmill blades 29 to rotate the windmill hub 28 with respect to the windmill support 27 as is known by those skilled in the art.

The stator 16 of the electromagnetic motor/generator 10 may be provided on the windmill support 27 generally adjacent to the windmill hub 28. The rotor 11 may be provided on the windmill hub 28 such that as the windmill hub 28 rotates, the rotor 11 rotates with respect to the stator 16 and the rotor magnets 13 (FIG. 3A) of the rotor 11 induce magnetic flux and electromotive force in the stator coils 17 (FIG. 3C) of the stator 16. Accordingly, electrical current is generated by the magnetic motor/generator 10 as was heretofore described with respect to FIGS. 3A-3D and may be stored in a suitable electrical storage facility or utilized directly.

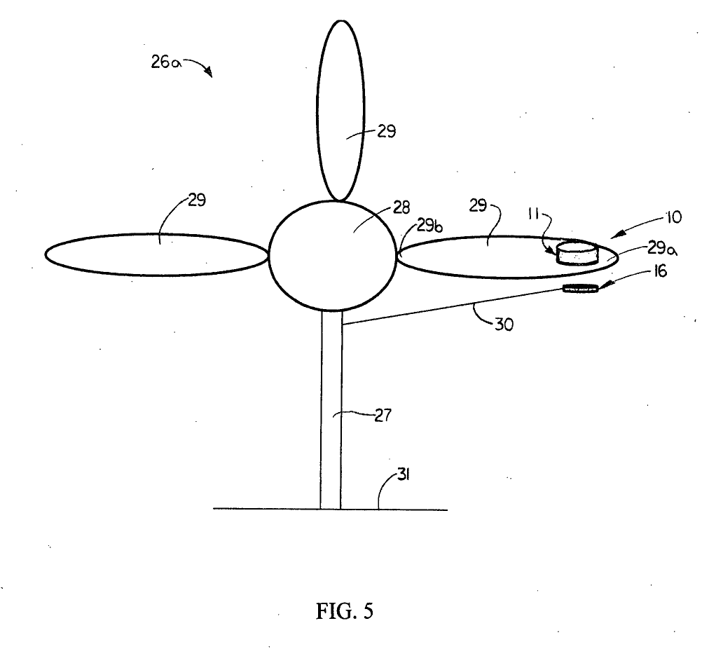

Referring next to FIG. 5 of the drawings, an alternative illustrative stationary embodiment of a windmill generator which utilizes a magnetic motor/generator 10 is generally indicated by reference numeral 26a. In the windmill generator 26a, the rotor 11 may be provided generally at or adjacent to the distal end 29a of a windmill blade 29. The stator 16 may be provided on a stationary support 30 such as a rod, for example and without limitation, which may extend from the windmill support 27. Accordingly, as the windmill blade 29 rotates past the stationary support 30, the rotor 11 moves adjacent to the stator 16 of the magnetic motor/generator 10 and the rotor magnets 13 (FIG. 3A) of the rotor 11 induce magnetic flux and electromotive force in the stator coils 17 (FIG. 3C) of the stator 16. Because the rotational speed of the rotor 11 is higher near the distal end 29a than the proximal end 29b of the windmill blade 29, the magnetic motor/generator 26a is capable of generating more torque than can be attained if the rotor 11 is located closer to the proximal end 29b of the windmill blade 29.

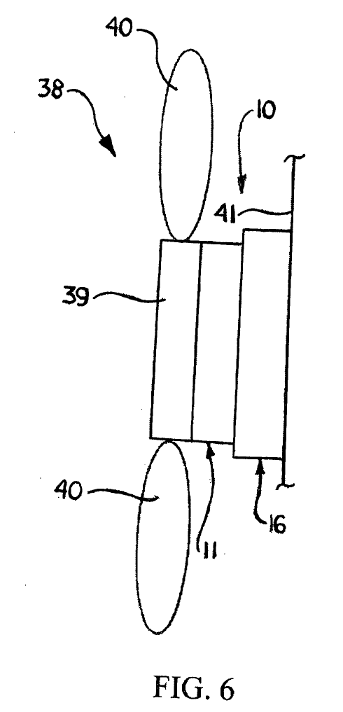

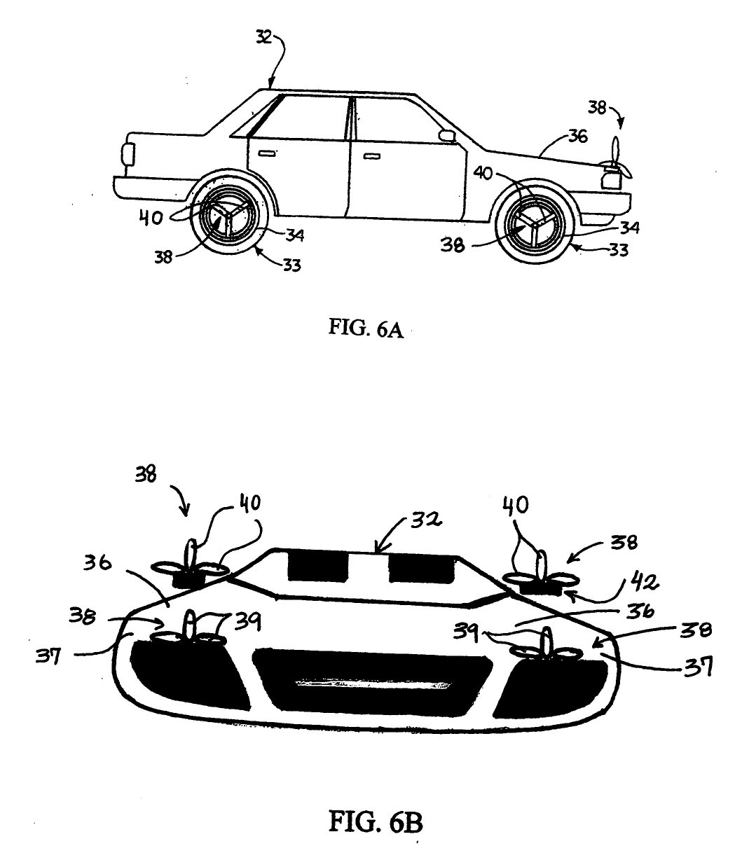

Referring next to FIG. 6 of the drawings, an illustrative portable embodiment of a windmill generator which utilizes an electromagnetic motor/generator 10 is generally indicated by reference numeral 38. The stator 16 of the electromagnetic motor/generator 10 may be provided on a stationary surface 41 which may be a hybrid electric vehicle, a locomotive, a bus or a cargo ship, for example and without limitation, as will be hereinafter described. The rotor 11 of the electromagnetic motor/generator 10 may be provided on a windmill hub 39 of the windmill generator 38. Windmill blades 40 may extend outwardly from the windmill hub 39. Accordingly, wind-actuated rotation of the windmill blades 40 and windmill hub 39 facilitates rotation of the rotor 11 with respect to the stator 16, generating electrical power which may be stored or utilized directly. The windmill hub 39 and windmill blades 40 of the windmill generator 38 may be a lightweight material such as plastic and/or composite materials, for example and without limitation.

Referring next to FIGS. 6, 6A and 7 of the drawings, in some applications the portable windmill generator 38 may be provided on one or multiple vehicle wheels 33 of a hybrid electric vehicle 32. As illustrated in FIG. 7, the stator 16 (FIG. 6) of the electromagnetic motor/generator 10 may be attached to the wheel hub 34 according to the knowledge of those skilled in the art. The stator coils 17 (FIG. 3B) of the stator 16 may be electrically connected to an electric motor (not illustrated) or a vehicle battery (not illustrated) of the hybrid electric vehicle 32. Accordingly, electrical power which is generated by the electromagnetic motor/generator 10 via wind-actuated rotation of the windmill blades 40 may be routed to the vehicle dynamo (not illustrated) to augment the torque generated by a gasoline internal combustion engine or alternatively, may be stored in the vehicle battery. As further illustrated in FIG. 6A, in some applications at least one portable windmill generator 38 may be additionally or alternatively provided on the vehicle hood 36 of the vehicle 32.

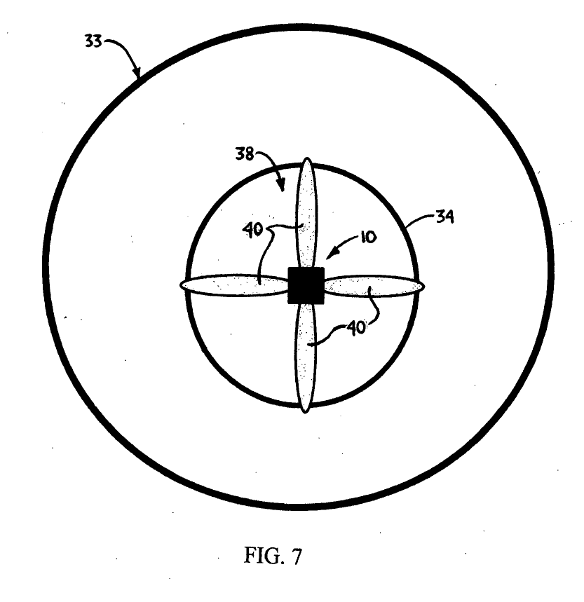

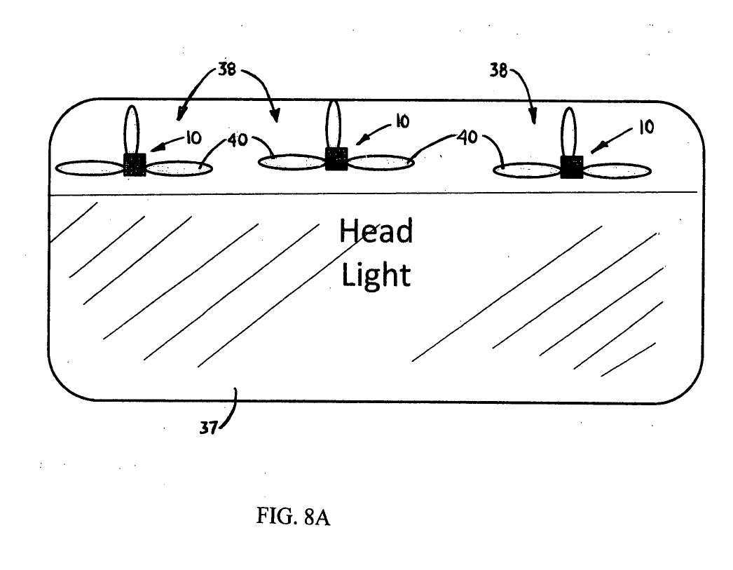

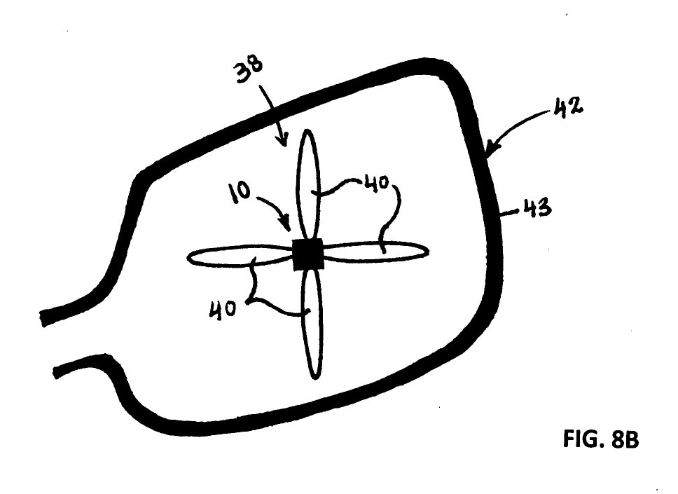

FIGS. 6B, 8A and 8B of the drawings illustrate additional or alternative exemplary areas of a hybrid electric vehicle 32 on which one or multiple portable windmill generators 38 may be mounted. As illustrated in FIG. 6B, in some applications a portable windmill generator 38 may be provided on one or both of the side view mirrors 42 of the vehicle 32. Additionally or alternatively, at least one portable windmill generator 38 may be provided on each vehicle headlight frame 37, as illustrated in FIGS. 6B and 8A. As illustrated in FIG. 8B, in some applications, at least one portable windmill generator 38 may be provided on the mirror backside 43 of one or both of the side view mirrors 42. In some applications, at least one portable windmill generator 38 may be provided inside the vehicle 32 next to the AC ventilator (not illustrated).

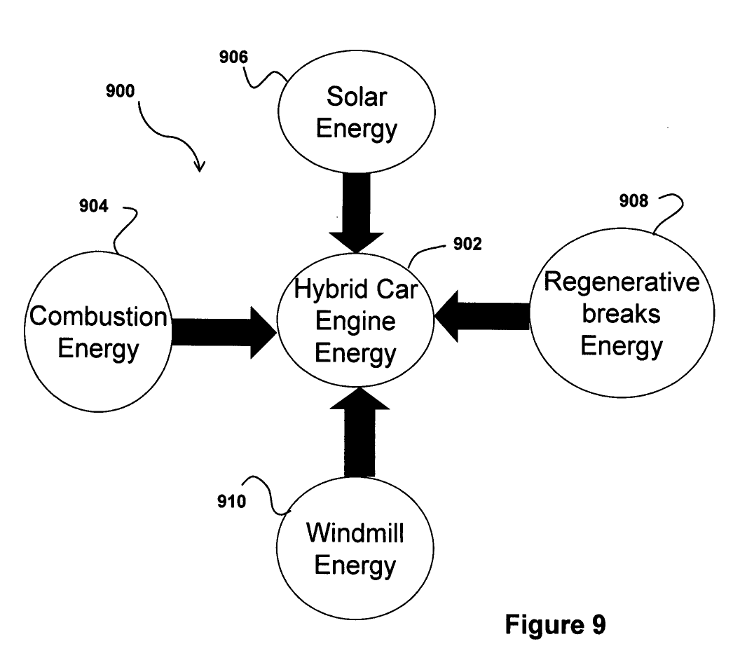

Referring next to FIG. 9 of the drawings, a schematic block diagram 900 illustrates multiple energy sources which can be utilized to power a hybrid electric vehicle. Hybrid car engine energy 902 may be generated via combustion energy 904, solar energy 906 and wheel motion energy 908 according to techniques and methods which are well known by those skilled in the art. Windmill energy 910 may be combined with the combustion energy 904, the solar energy 906 and the wheel motion energy 908 to augment the hybrid car engine energy 902. Electrical current which is generated by the portable windmill generator 38 (FIG. 6) may be coupled to a vehicle dynamo (not illustrated) and to solar cells (not illustrated) to augment the torque generated by a gasoline internal combustion engine of the hybrid electric vehicle. Additionally or alternatively, the electrical current which is generated by the portable windmill generator 38 may be stored in the vehicle batteries (not illustrated). The current and voltage generated by the portable windmill generator 38 may be coupled with the electrical current which is generated by the vehicle dynamo or solar cells through a delta or y connection and stored either in a battery or used directly to generate torque to propel the vehicle.

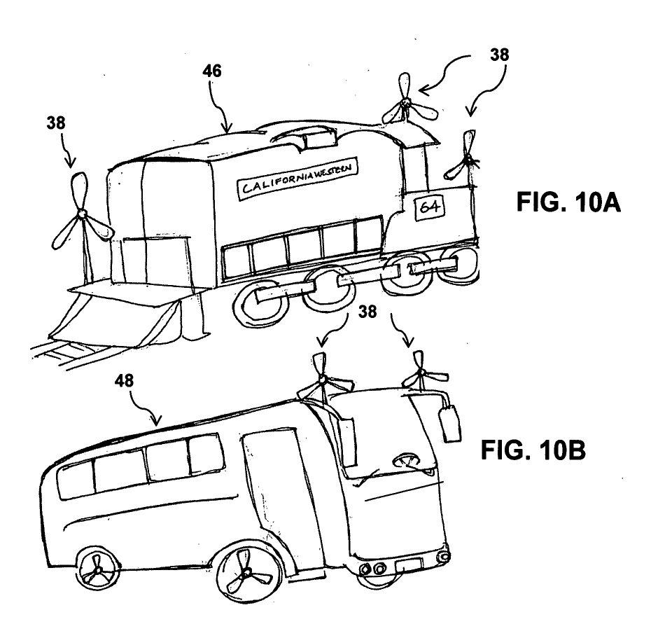

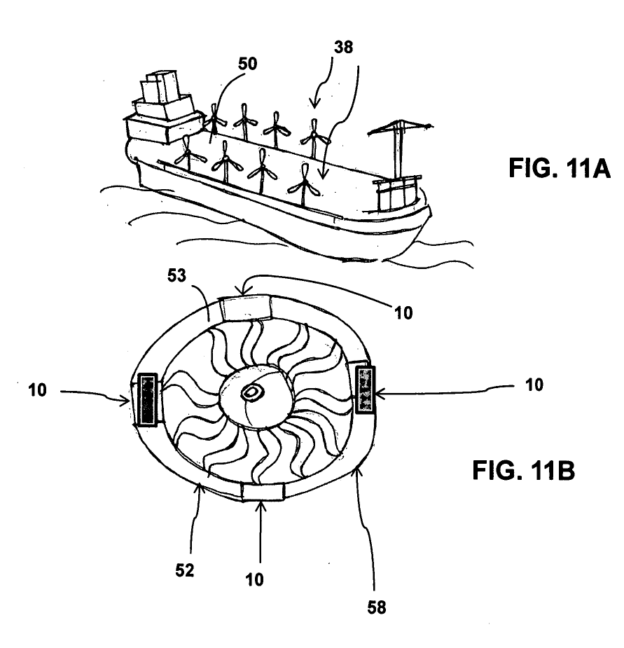

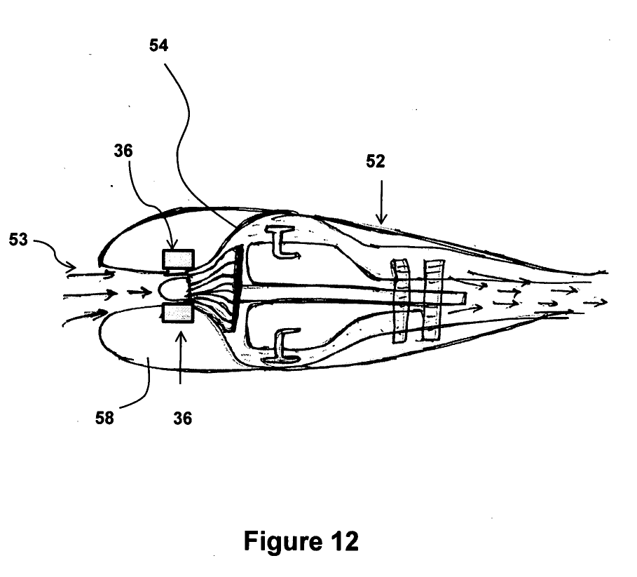

Additional applications of the portable windmill generator 38 are illustrated in FIGS. 10A-14 of the drawings. One or multiple portable windmill generators 38 may be provided on a locomotive 46 (FIG. 10A), a bus 48 (FIG. 10B) or a cargo ship 50 (FIG. 11A) for the purpose of contributing to the electrical power which is available for operation of the various electrical components of the locomotive 46, bus 48 or cargo ship 50. As illustrated in FIG. 11B, in some applications one or multiple portable windmill generators 38 may be placed on the engine cowling 58 at the air intake 53 of a jet engine 52. Accordingly, air flowing into the air intake 53 operates the portable windmill generator or generators 38, which generate electrical power for the electrical components of the aircraft (not illustrated) of which the jet engine 52 is a part. As illustrated in FIG. 12, in some applications at least one portable windmill generator 38 may be provided in the air intake 53 in front of the compressor 54 of the jet engine 52. Accordingly, air flowing into the air intake 53 operates the portable windmill 38 which generates electrical power for the electrical components for the aircraft.

Referring next to FIG. 13, in some applications at least one portable windmill generator 38 may be provided on a bicycle 60. Exemplary locations for the portable windmill generator 38 include the front wheel 61, the rear wheel 62 and the handlebars 63. As an operator (not illustrated) pedals the bicycle 60, forward movement of the bicycle 60 causes wind to operate each portable windmill generator 38. Electrical current which is generated by each portable windmill generator 38 may be used to power a cell phone (not illustrated), an audio/video media player (not illustrated) or other electronic accessory which may be carried by the operator of the bicycle 60.

Referring next to FIG. 14 of the drawings, in some applications at least one portable windmill generator 38 may be provided on a cap 70 which is worn on the head 67 of a runner 66. As the runner 66 runs, forward movement of the runner 66 causes wind to operate each portable windmill generator 38. Electrical current which is generated by each portable windmill generator 38 may be used to power a cell phone (not illustrated), an audio/video media player (not illustrated) or other electronic accessory which may be carried by the runner 66.

It will be appreciated by those skilled in the art that the magnets 13 of the electromagnetic motor/generator 10 which is used in implementation of the stationary windmill generator 26 and the portable windmill generator 38 may utilize focused permanent magnetic arrays with increased flux instead of regular permanent magnets. Since the Ronbach arrays can be designed to have a dominant north pole or south pole, steel plates need not be used to shield the magnetic flux on the other side of the magnet 13. This may result in reduced weight of the electric motor/generator 10 and hence, more stability at higher speeds. Since the Ronbach arrays of magnets 13 can be designed to create magnetic fluxes with a specified profile or shape, they can be customized for specific windmill generator applications. In some applications, regular permanent magnets can be used in combination with Ronbach magnets in the electromagnetic motor/generator 10 as the application demands. The portable windmill generator 38 can be used to tap the energy of air or wind which is generated by moving vehicles, humans or animals which hitherto remain a largely untapped source of energy in day-to-day living environments. While conventional windmill generators are largely restricted to remote high-wind regions which may vary seasonally, the portable windmill generator 38 may be deployed in urban or remote settings. Use of the portable windmill generator 38 has little or no environmental impact.

While the embodiments of the disclosure have been described above, it will be recognized and understood that various modifications can be made and the appended claims are intended to cover all such modifications which may fall within the spirit and scope of the disclosure.

What is claimed is:

1. A windmill generator, comprising:
a windmill hub;
at least one windmill blade carried by the windmill hub;
a rotor carried by at least one of the windmill hub and the windmill blade and having a plurality of rotor magnets with dominant north poles and dominant south poles, respectively; and
a stator having a plurality of stator coils disposed adjacent to the rotor magnets of the rotor, with the rotor rotatable with respect to the stator.

2. The windmill generator of claim 1 wherein each of the stator coils comprises a plurality of coil windings.

3. The windmill generator of claim 2 wherein the plurality of coil windings comprises three coil windings.

4. The windmill generator of claim 1 wherein the rotor comprises a circular rotor frame and wherein the rotor magnets extend from the rotor frame.

5. The windmill generator of claim 1 wherein the plurality of stator coils comprises at least nine stator coils and the plurality of rotor magnets comprises at least twelve rotor magnets.

6. The windmill generator of claim 5 further comprising a first coil wiring, a second coil wiring and a third coil wiring and wherein the stator coils comprises a first set of three stator coils wound from the first coil wiring, a second set of three stator coils wound from the second coil wiring and a third set of stator coils wound from the third coil wiring.

7. The windmill generator of claim 6 wherein the first set of stator coils, the second set of stator coils and the third set of stator coils alternate with each other in the stator.

8. The windmill generator of claim 6 wherein the first coil wiring, the second coil wiring and the third coil wiring have first ends and second ends, respectively, terminating at a common wiring junction.

9. The windmill generator of claim 8 further comprising a first coil output, a second coil output and a third coil output terminating second ends of the first coil wiring, the second coil wiring and the third coil wiring, respectively.

10. A windmill generator, comprising:
a windmill support;
a windmill hub carried by the windmill support;
a plurality of windmill blades carried by the windmill hub;
a stator having a plurality of stator coils carried by at least one of the windmill hub and the windmill blades; and
a rotor disposed adjacent to the stator coils of the stator and rotatable with respect to the stator and having a plurality of rotor magnets with dominant north poles and dominant south poles, respectively.

11. The windmill generator of claim 10 wherein the stator is carried by the windmill support and the rotor is carried by the windmill hub.

12. The windmill generator of claim 10 wherein the rotor is carried by at least one of the windmill blades.

13. The windmill generator of claim 10 further comprising a stationary support carried by the windmill support and wherein the stator is carried by the stationary support.

14. The windmill generator of claim 13 wherein each of the windmill blades has a proximal end carried by the windmill hub and a distal end spaced-apart from the proximal end, and wherein the rotor is carried by the distal end of the windmill blade.

15. A portable windmill generator, comprising:
a stator having a plurality of stator coils and adapted for attachment to a stationary surface;
a rotor having a plurality of rotor magnets disposed adjacent to the stator coils of the stator and rotatable with respect to the stator and having dominant north poles and dominant south poles, respectively;
a windmill hub carried by the rotor; and
a plurality of windmill blades carried by the windmill hub.

16. The portable windmill generator of claim 15 wherein the stationary surface comprises a vehicle.

17. The portable windmill generator of claim 16 wherein the vehicle comprises a hybrid electric vehicle.

18. The portable windmill generator of claim 15 wherein the stationary surface comprises a jet engine.

19. The portable windmill generator of claim 15 wherein the stationary surface comprises a vehicle wheel.

20. The portable windmill generator of claim 16 wherein the stationary surface comprises a cap.
